(19) United States
(12) Patent Application Publication
(10) Pub. No.: US 2005/0007231 A1
(43) Pub. Date: Jan. 13, 2005

(54) High voltage bobbin of fly-back transformer

(76) Inventors: Myung Hwan Kim, Hwasung-gun (KR); Chang Ho Seo, Suwon (KR)

Correspondence Address: LOWE HAUPTMAN GILMAN & BERNER, LLP, Suite 310, 1700 Diagonal Road, Alexandria, VA, 22314, US

(21) Appl. No.: 10/699,841

(22) Filed: Nov. 4, 2003

(30) Foreign Application Priority Data
Jul. 9, 2003 (KR) 2003-46497

(51) Int. Cl. H01F 27/30

(52) U.S. Cl. 336/198

(57) ABSTRACT

Disclosed is a high voltage bobbin of a fly back transformer for outputting high voltage. The high voltage bobbin of the invention comprises a bobbin body having a central hole for receiving a low voltage bobbin wound with a low voltage wire; input and output terminal sections integrally formed in upper and lower portions of the bobbin body and mounted with pluralities of input and output terminal pins; a plurality of insulating film layers wound on an outer surface of the bobbin body; high voltage wires each wound between two adjacent ones of the insulating film layers; and input and output hooks integrally formed on the outer surface of the bobbin body. The input hook catches a first one of the high voltage wires before the first wire is wound on the bobbin body, and the output hook catches the first wire wound on the bobbin body before the first wire is extended to the outside. The invention excludes winding a first insulating film on the high voltage bobbin before winding a first wire on the high voltage bobbin in order to save fabrication cost as well as decrease the number of process steps thereby enhancing the competitiveness of the high voltage bobbin and thus the fly-back transformer.

### BACKGROUND OF THE INVENTION

1. Field of the Invention

The present invention relates to a fly-back transformer, and more particularly, to a high voltage bobbin of a fly-back transformer having an improved structure which can exclude winding a first insulating film on the high voltage bobbin before winding a first wire on the high voltage bobbin in order to save fabrication cost as well as decrease the number of process steps thereby enhancing the competitiveness of the high voltage bobbin and thus the fly-back transformer.

2. Description of the Related Art

In general, a fly-back transformer is installed within a Braun tube or CRT of a TV set or a monitor to multiply pulse voltage outputted from a horizontal output circuit by tens of times and generate high DC voltage.

FIG. 1 is an exploded perspective view of a typical fly-back transformer. As shown in FIG. 1, the fly-back transformer 100 comprises a low voltage bobbin 110 having a bobbin body 112 and a low voltage wire (not shown) wound on the bobbin body 112 to form a first coil, a high voltage bobbin 120 having a hollow bobbin body 122 for receiving the low voltage bobbin 110 and high voltage wires 121 wound on the bobbin body 122 to form a second coil of multiple layers, a plurality of high voltage commutating diodes 125, a focus pack or focus unit 130 electrically connected with a high voltage output terminal of the high voltage bobbin 120 and an fly-back transformer housing (not shown) for containing the low and high voltage bobbins 110 and 120. A bleeder resistor 135 is contained within the focus unit 130, and a plurality of knobs (not shown) are mounted on the focus unit 130 for changing focus and screen voltages of a Braun tube.

In the fly-back transformer 100 of the above construction, the high voltage wires 121 are wound on the high voltage bobbin 120 to form the plurality of coil layers stacked one atop another in a radial direction, in which a first insulating film 140 made of insulating material is closely wound on the bobbin body 122 in the form of a hollow cylinder. At a rear end of the first insulating film 140, there are formed at least one deposition point to prevent unwinding of the insulating film 140 which is wound on the bobbin body 122 for several times.

Referring to FIG. 2, the insulating film 140 wound on the bobbin body 122 is an insulating member of a predetermined length, and has front and rear ends which are cut to a predetermined inclination. The insulating film 140 also has upper and lower lugs 142 and 144 notched in upper and lower edges of the rear end.

The high voltage wires 121 are wound by a coil winder (not shown) on the first insulating film 140 which are wound on the bobbin body 122 for several times. A first one of the wires 121 is connected by one end with a first one of lower pin terminals 124 associated with a first one of the diodes 125, and is caught by the lower lug 144 to sharply change its direction, and leads from the bottom to the top of the bobbin body 122 while being wound thereon.

At the point of substantially finishing winding the first wire 121 on the bobbin body 122, the first wire 121 is caught by the upper lug 142 of the insulating film 140 to sharply change its direction before leads to the outside, and then connected with an upper terminal pin which is connected with the first diode 125 so as to finish first winding.

In succession, a second one of the insulating films 140 is fixedly wound on the first high voltage wire 121 which is wound on the bobbin body 122, and then a second one of wires 121 is wound on the outer surface of the second insulating film 140 in a fashion similar to above first winding. The wires and the insulating films are wound in a radial direction for several times as above to form a plurality of insulating film layers so that the coil layers each are interposed between two adjacent ones of the insulating film layers. Finally, an outermost one of the insulating films 140 is wound on the outer surface of an outermost one of the coil layers to insulate the outermost coil layer from the outside.

As a result, in application of electric power, potential difference of the high voltage wires 121 in the coil layers generates high voltage, which is supplied to the Braun tube via an anode cable.

In winding the wires on the conventional high voltage bobbin 120, however, the first insulating film 1403 with the upper and lower lugs 142 and 144 is wound on the outer surface of the bobbin body before the first wire 121 is wound on the bobbin body, and then subsequent works are repeatedly carried out. As a result, the winding work of the first insulating film is very troublesome and increases the number of process steps. This also consumes the insulating film by a large quantity thereby worsening price competitiveness.

### SUMMARY OF THE INVENTION

Accordingly, the present invention has been made to solve the foregoing problems of the prior art and it is therefore an object of the present invention to provide a high voltage bobbin of a fly-back transformer capable of excluding a first insulating film which is directly wound on an outer surface of the high voltage bobbin and a winding work of the first insulating film in order to save fabrication cost as well as decrease the number of process steps thereby enhancing price competitiveness.

According to an aspect of the invention, it is provided a high voltage bobbin of a fly back transformer for outputting high voltage, comprising: a bobbin body having a central hole for receiving a low voltage bobbin wound with a low voltage wire; input and output terminal sections integrally formed in upper and lower portions of the bobbin body and mounted with pluralities of input and output terminal pins; a plurality of insulating film layers wound on an outer surface of the bobbin body; high voltage wires each wound between two adjacent ones of the insulating film layers; input and output hooks integrally formed on the outer surface of the bobbin body, wherein the input hook catches a first one of the high voltage wires before the first wire is wound on the bobbin body, and the output hook catches the first wire wound on the bobbin body before the first wire is extended to the outside.

It is preferred that each of the input and output hooks has a tapered configuration defined by a lower surface integrally connected by one end with an outer surface portion of the bobbin body and an upper surface contacting a lower surface portion of the insulating film, wherein the distance between the lower and upper surfaces gradually decreases toward a front end of each of the input and output hooks so that the lower surface meets the upper surface of the front end.

It is preferred that the input and output hooks are formed on a parting line between upper and lower molds for molding the bobbin body.

It is also preferred that the input hook on the parting line has a front end oriented counter to a winding direction of the high voltage wires, and the output hook on the parting line has a front end oriented in the winding direction of the high voltage wires.

It is preferred that the input and output hooks are formed on the parting line which is formed perpendicularly to the input and output terminal pins connected with both ends of the first high voltage wire.

It is also preferred that each of the input and output hooks has an arc-shaped upper surface which is formed at a radius of curvature substantially equal to that of the outer surface of the bobbin body.

The high voltage bobbin of a fly back transformer according to the invention may further comprise upper and lower triangular clearances formed respectively in interfaces between the bobbin body and the input and output terminal sections for closely contacting the first high voltage wire with the outer surface of the bobbin body, the first high voltage wire being caught by the input and output hooks.

The high voltage bobbin of a fly back transformer according to the invention may further comprise a plurality of insulating film-contacting blocks formed radially on the outer surface of the bobbin body having the input and output hooks, to a predetermined interval.

It is preferred that each of the insulating film-contacting blocks has an upper surface which is formed at a radius of curvature substantially equal to that of the outer surface of the bobbin body.

It is preferred that each of the insulating film-contacting blocks has an uppermost surface which is formed to a height substantially equal to that of an uppermost surface of each of the input and outer hooks.

It is also preferred that at least one of the insulating film-contacting blocks is formed wider than the input and output hooks to function as support points in fusion of terminal ends of the insulating films which are completed of winding.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a general fly-back transformer;

FIG. 2 illustrates an insulating film adopted in the general fly-back transformer;

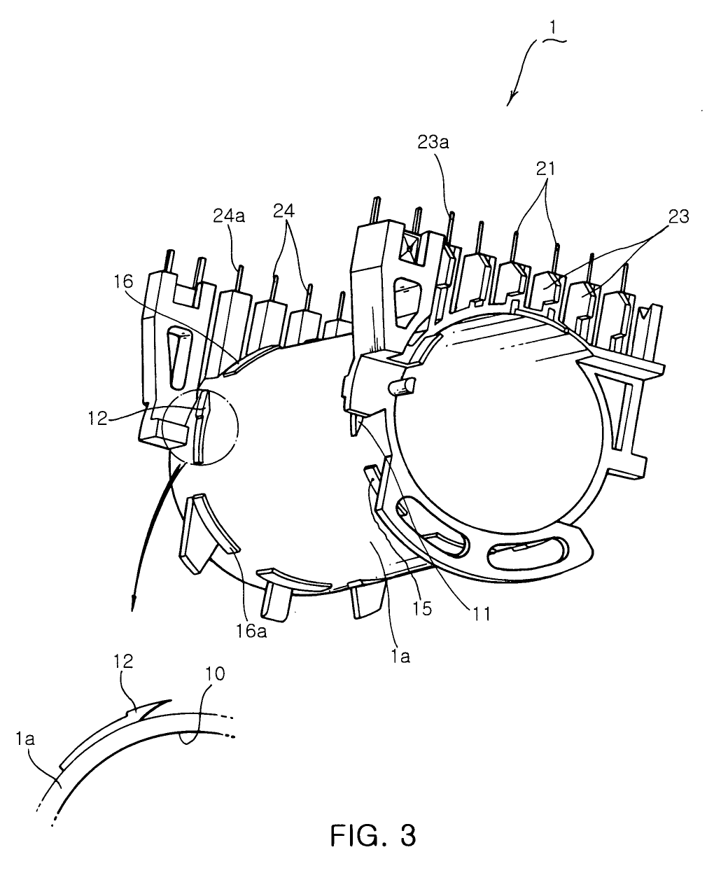

FIG. 3 is a perspective view of a high voltage bobbin of a fly-back transformer according to the invention;

FIG. 4a is a plan view of the high voltage bobbin of a fly-back transformer according to the invention;

FIG. 4b is a bottom view of the high voltage bobbin of a fly-back transformer according to the invention;

FIG. 5 is a perspective view of the high voltage bobbin of a fly-back transformer according to the invention on which a high voltage wire is wound;

FIGS. 6a through 6c are side elevation views of the high voltage bobbin of the fly-back transformer of the invention at intervals of 90 degrees;

FIGS. 7a and 7b illustrate a wire-winding work where a first terminal pin is placed beyond an imaginary line in the high voltage bobbin of a fly-back transformer according to the invention, in which FIG. 7a is a side elevation view of the high voltage bobbin, and FIG. 7b is a plan view thereof; and

FIGS. 8a and 8b illustrate a wire-winding work where the first terminal pin is placed within the imaginary line in the high voltage bobbin of a fly-back transformer according to the invention, in which FIG. 8a is a side elevation view of the high voltage bobbin, and FIG. 8b is a plan view thereof.

### DETAILED DESCRIPTION OF THE PREFERRED EMBODIMENT

The following detailed description will present a preferred embodiment of the invention in reference to the accompanying drawings.

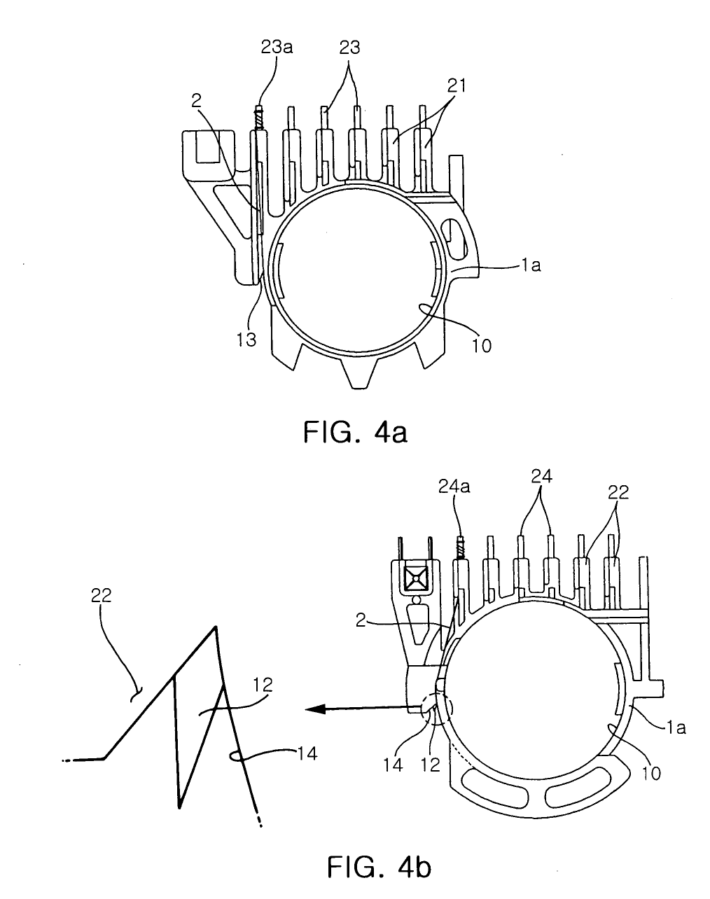

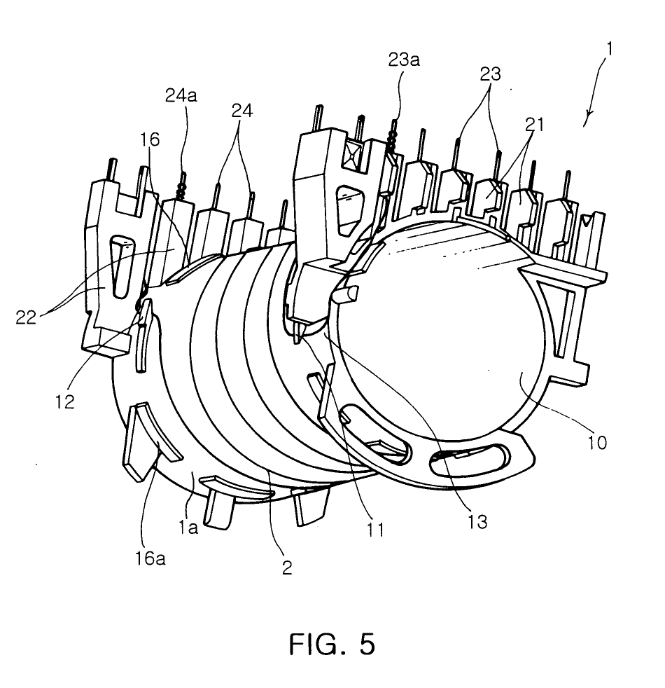

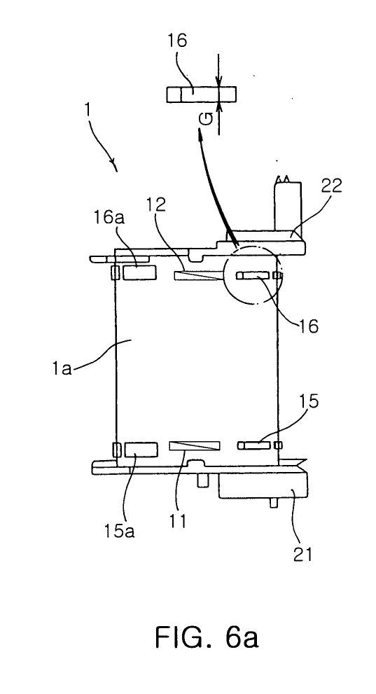

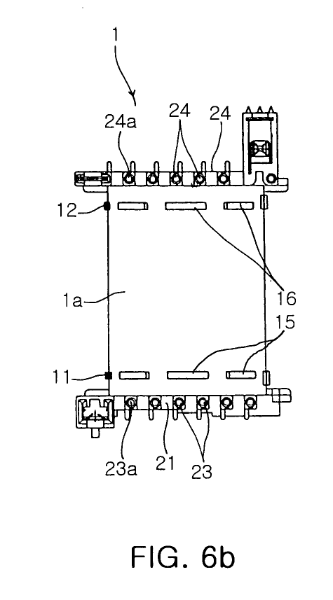

FIG. 3 is a perspective view of a high voltage bobbin of a fly-back transformer according to the invention, FIG. 4A is a plan view of the high voltage bobbin of a fly-back transformer according to the invention, FIG. 4B is a bottom view of the high voltage bobbin of a fly-back transformer according to the invention, and FIG. 5 is a perspective view of the high voltage bobbin of a fly-back transformer according to the invention on which a high voltage wire is wound.

The high voltage bobbin 1 of the invention is adopted in a fly-back transformer 100 which multiplies pulse voltage outputted from a horizontal output circuit by tens of times. The high voltage bobbin 1 of the invention has a bobbin body 1a of an improved structure to exclude a first one of insulating films which was wounded on the outer surface of the bobbin body 1a and a winding operation of the first film thereby reducing the number of process steps and component-assembling works. Referring to FIGS. 3 through 5, the high voltage bobbin 1 has input and output hooks 11 and 12 projected respectively from outer surface portions of the bobbin body 1a on which a first high voltage wire 2 is wound.

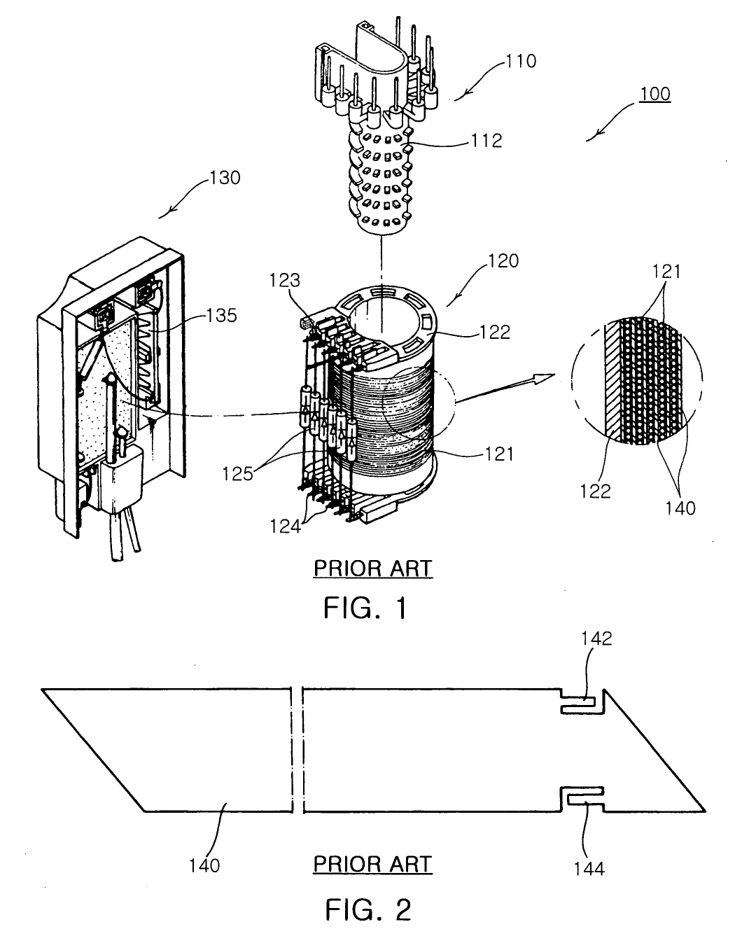

As shown in FIG. 1, the fly-back transformer 100 comprises a low voltage bobbin 110 wound with a low voltage wire, a focus unit 130 electrically connected with a high voltage output terminal of the high voltage bobbin 1 and a fly-back transformer housing for housing the low and high voltage bobbins 110 and 1 therein, in which detailed description of these components will be omitted.

That is, in the high voltage bobbin 1, the bobbin body 1a is shaped as a hollow cylinder having opened upper and lower ends and a central through hole 10 in which the low voltage bobbin 110 will be placed in an overlapping fashion. The high voltage bobbin 1 also has input and output terminal sections 21 and 22 which are integrally arranged in upper and lower outer peripheral portions of the bobbin body 1a and have a plurality of pin holes for mounting a plurality of input and output terminal pins 23 and 24.

In the input and output hooks 11 and 12 projected from the outer surface of the bobbin body 1a, the input hook 11 is projected from the lower outer peripheral portion of the bobbin body 1a, adjacent to the input terminal section 21. Then, in a winding operation of the high voltage wire 2, the input hook 11 catches the first high voltage wire 2 which is fixedly wound by one end on a first input terminal pin 23a of the input terminal pins 23 before the first high voltage wire 2 is wound on the outer surface of the bobbin body 1a.

The output hook 12 is projected from the upper outer peripheral portion of the bobbin body 1a, adjacent to the output terminal section 21, so as to catch the first high voltage wire 2 which is caught by the input hook 11 and wound on the bobbin body 1a before the first high voltage wire 2 is connected with a first output terminal pin 24a of the output terminal pins 24.

Each of the input and output hooks 11 and 12 has a lower surface integrally connected by one end with an outer surface portion of the bobbin body 1a and an upper surface contacting a lower surface portion of the first insulating film. The input and output hooks 11 and 12 each have a tapered configuration in which the distance between the lower and upper surfaces gradually decreases toward a front end of each of the input and output hooks 11 and 12 so that the lower surface meets the upper surface at the front end.

The upper surface contacting with the lower surface portion of the first insulating film preferably has a radius of curvature substantially equal to that of the outer surface of the bobbin body 1a.

Where the bobbin body 1a is formed in upper and lower molds (not shown), the input and output hooks 11 and 12 are formed on a parting line on which upper and lower molds meet together. The front end of the input hook 11 is oriented counter to the direction of winding the high voltage wire 2, whereas the front end of the output hook 12 is oriented to the direction of winding the high voltage wire 2.

As a result, in fabrication of the bobbin body 1a with the upper and lower molds, the input and output hooks 11 and 12 can be readily formed free from interference with the molds when the molds are separated from the bobbin body 1a.

In observation of the bobbin body 1a on a plane, the input and output hooks 11 and 12 are formed on the parting line which is extended perpendicularly to the first input and output terminal pins 22a and 24a which are connected respectively with the ends of the first high voltage wire 2.

In interfaces between the bobbin body 1a and the input and output terminal sections 21 and 22, there are formed upper and lower triangular clearances 13 and 14 to help the first high voltage wire 2, which is extended along the input terminal pin 23a, the input hook 11, the output hook 12 and the output terminal pin 24a, closely contact the outer surface of the bobbin body 1a, be easily introduced toward the bobbin body 1a, and be easily pulled out toward the input and output terminal pins 23a and 24a.

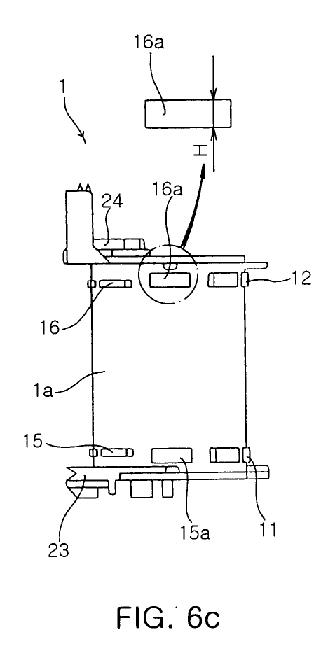

FIGS. 6a through 6c are side elevation views of the high voltage bobbin of the fly-back transformer of the invention at intervals of 90 degrees. As shown in FIGS. 6a through 6c, on the outer surface of the bobbin body 1a having the input and output hooks 11 and 12, there are radially formed a plurality of insulating film-contacting blocks 15 and 16 at a predetermined interval.

Each of the insulating film-contacting blocks 15 and 16 has an arc-shaped upper surface which is preferably formed at a radius of curvature substantially equal to that of the outer surface of the bobbin body 1a. The uppermost surface of each of the insulating film-contacting blocks 15 and 16 is formed to a height substantially equal to the upper surface of each of the input and output hooks 11 and 12.

Then, the first insulating film 140 which is wound on the outer surface of the bobbin body 1a after winding the first high voltage wire 2 on the outer surface of the bobbin body 1a is uniformly contacted with the upper surfaces of the input and output hooks 11 and 12 as well as the upper surfaces of the insulating film-contacting blocks 15 and 16 so that the first insulating film 140 has a circular cross section which is substantially equal to that of the bobbin body 1a upon completion of winding on the bobbin body 1a.

Some of the insulating film-contacting blocks 15 and 16 projected from the outer surface of the bobbin body 1a are preferably comprised of support blocks 15a and 16b which have a width H larger than the width G of the input and output hooks 11 and 12 and a height at least substantially equal to that of the input and output hooks 11 and 12 to potentially function as support points when terminal ends of the insulating films are fused upon completion of winding.

The support blocks 15a and 16a are preferably formed in portions of the bobbin body 1a which are connected respectively with upper and lower ends of the diodes 125 and in which the input and output terminals 21 and 22 are not formed. As a result, this can form at least one fusion point with respect to the terminal end of the first insulating film free from interference with any members such as the diodes upon completion of winding the first insulating film.

Hereinafter description will be made to the operation of the invention having the above construction.

Before the low voltage bobbin 110 wound with the low voltage wire is inserted into the central through hole 10 of the high voltage bobbin 1, the high voltage wires 2 are wound on the high voltage bobbin 1 to form the high voltage coil layers and the insulating films 140 are wound respectively between two adjacent ones of the high voltage coil layers.

In winding the first high voltage wire 2 on the outer surface of the bobbin body 1a having the input and output hooks 11 and 12 which are formed on the same parting line, one end of the wire 2 is connected with the first input terminal pin 23a in vicinity of the input hook 11 of the input terminal pins 23 which are provided in the output terminal section 21 arranged in a lower portion of the bobbin body 1a, and then introduced toward the bobbin body 1a.

Upon being introduced toward the bobbin body 1a, the first wire 2 is extended through the lower triangular clearance 13 formed in the interference between the lower outer peripheral portion of the bobbin body 1a and the input terminal section 21, and caught by the input hook 11 which has the front end protruded counter to the winding direction of the wire 2. Then, the first wire 2 is wound for several times by a coil winder while it leads from the lower portion to the upper portion of the bobbin body 1a.

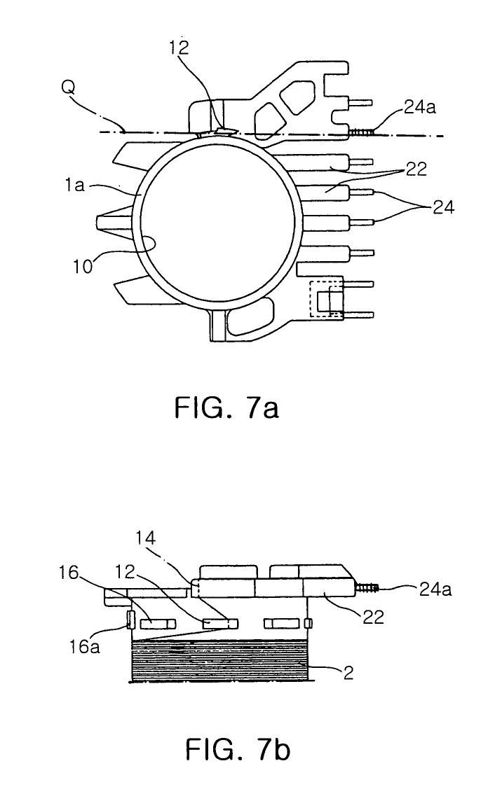

In succession, as shown in FIGS. 7a and 7b, where the first output terminal pin 24a of the output terminal pins 24 arranged in the outer upper portion of the bobbin body 1a is placed past the output hook 12 and beyond an imaginary line Q which is parallel with the output terminal pins 24, as the first wire 2 approaches the output hook 12 while being wound on the bobbin body 1a from the lower portion to the upper portion thereof, the wire 2 is caught by the output hook 12 with the front end extended in the winding direction of the wire, turns toward the output terminal section, passes through the upper triangular clearance 14 defined in the interference between the output terminal section 22 and the upper outer surface portion of the bobbin body 1a, and then is connected with the first output terminal pin 24a of the output terminal pins 24 which are arranged in the output terminal section 22.

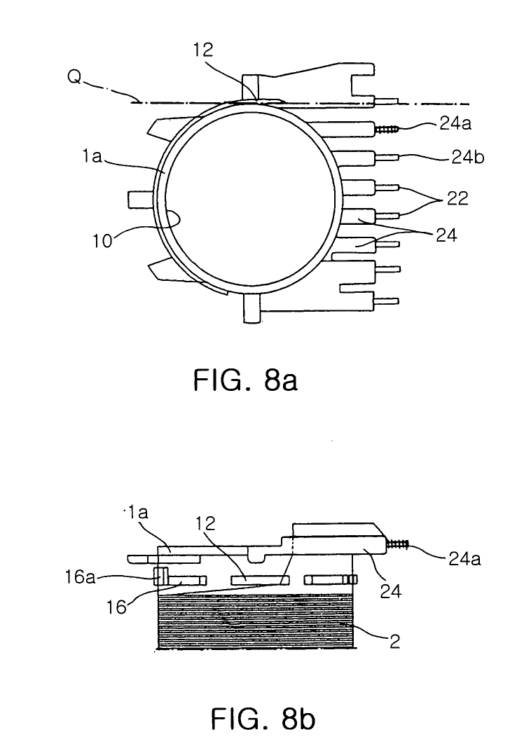

As shown in FIGS. 8a and 8b, where the first output terminal pin 24a of the output terminal pins 24 arranged in the outer upper portion of the bobbin body 1a is placed past the output hook 12 and within the imaginary line Q which is parallel with the output terminal pins 24, as the first wire 2 approaches the output hook 12 while being wound on the bobbin body 1a from the lower portion to the upper portion, the wire 2 is caught by the output hook 12, turns toward the output terminal section 22, passes through the first output terminal pin 24a and the second output terminal pin 24 of the output terminal pins 24 arranged in the output terminal section 22 without passing through the upper triangular clearance 14, and then is electrically connected with the first output terminal pin 24a.

Upon completion of winding the first high voltage wire on the bobbin body 1a of the high voltage bobbin 1 as above, the insulating film 140 which has upper and lower lugs 142 and 144 punched in upper and lower edges of the terminal end thereof is wound on the first high voltage wire to form the first insulating film layer. After completion of winding the first insulating film 140, at least one fusion point is formed by providing a heat source right above the support blocks 15a and 16a in the bobbin body 1a as well as pressing the terminal end of the insulating film 140 so that the terminal end of the insulating film 140 is fixed in position without being untied.

In succession, a second one of the wires 2 is wound on the first insulating film 140 wound on the bobbin body 1a, in which upper and lower end portions of the second wire are caught respectively by the upper and lower lugs 142 and 144 of the first insulating film 140.

Upon completion of winding the wires 2 on the bobbin body 1a in the multiple coil layers along with the insulating films 140 each between two adjacent ones of the coil layers, the diodes 125 are connected between corresponding ones of the input and output terminal pins by soldering upper and lower ends of the diodes 125 to the corresponding input and output terminal pins which are electrically connected with the both ends of the wires wound in the respective layers.

According to the present invention as set forth above, the input and output hooks are formed on the outer surface of the bobbin body on which the high voltage wires are wound and the insulating films are wound respectively between two adjacent ones of the wires in order to exclude the first insulating film which was directly wound on the outer surface of the high voltage bobbin and the winding work of the first insulating film. This can decrease the number of process steps for winding the films as well as the number of components to save fabrication cost. As a result, the present invention can save the fabrication cost of a fly-back transformer end item thereby further enhancing the price competitiveness thereof.

Although the preferred embodiment of the present invention has been disclosed for illustrative purposes, it is to be understood by those skilled in the art that various modifications, additions and substitutions can be made without departing from the spirit and scope of the invention as disclosed in the accompanying claims.

1. A high voltage bobbin of a fly back transformer for outputting high voltage, comprising:
a bobbin body having a central hole for receiving a low voltage bobbin wound with a low voltage wire;
input and output terminal sections integrally formed in upper and lower portions of the bobbin body and mounted with pluralities of input and output terminal pins;
a plurality of insulating film layers wound on an outer surface of the bobbin body;
high voltage wires each wound between two adjacent ones of the insulating film layers;
input and output hooks integrally formed on the outer surface of the bobbin body, wherein the input hook catches a first one of the high voltage wires before the first wire is wound on the bobbin body, and the output hook catches the first wire wound on the bobbin body before the first wire is extended to the outside.

2. The high voltage bobbin of a fly back transformer as set forth in claim 1, wherein each of the input and output hooks has a tapered configuration defined by a lower surface integrally connected by one end with an outer surface portion of the bobbin body and an upper surface contacting a lower surface portion of the insulating film, wherein the distance between the lower and upper surfaces gradually decreases toward a front end of each of the input and output hooks so that the lower surface meets the upper surface of the front end.

3. The high voltage bobbin of a fly back transformer as set forth in claim 1, wherein the input and output hooks are formed on a parting line between upper and lower molds for molding the bobbin body.

4. The high voltage bobbin of a fly back transformer as set forth in claim 3, wherein the input hook on the parting line has a front end oriented counter to a winding direction of the high voltage wires, and the output hook on the parting line has a front end oriented in the winding direction of the high voltage wires.

5. The high voltage bobbin of a fly back transformer as set forth in claim 3, wherein the input and output hooks are formed on the parting line which is formed perpendicularly to the input and output terminal pins connected with both ends of the first high voltage wire.

6. The high voltage bobbin of a fly back transformer as set forth in claim 1, wherein each of the input and output hooks has an arc-shaped upper surface which is formed at a radius of curvature substantially equal to that of the outer surface of the bobbin body.

7. The high voltage bobbin of a fly back transformer as set forth in claim 1, further comprising upper and lower triangular clearances formed respectively in interfaces between the bobbin body and the input and output terminal sections for closely contacting the first high voltage wire with the outer surface of the bobbin body, the first high voltage wire being caught by the input and output hooks.

8. The high voltage bobbin of a fly back transformer as set forth in claim 1, further comprising a plurality of insulating film-contacting blocks formed radially on the outer surface of the bobbin body having the input and output hooks, to a predetermined interval.

9. The high voltage bobbin of a fly back transformer as set forth in claim 8, wherein each of the insulating film-contacting blocks has an upper surface which is formed at a radius of curvature substantially equal to that of the outer surface of the bobbin body.

10. The high voltage bobbin of a fly back transformer as set forth in claim 8, wherein each of the insulating film-contacting blocks has an uppermost surface which is formed to a height substantially equal to that of an uppermost surface of each of the input and outer hooks.

11. The high voltage bobbin of a fly back transformer as set forth in claim 8, wherein at least one of the insulating film-contacting blocks is formed wider than the input and output hooks to function as support points in fusion of terminal ends of the insulating films which are completed of winding.
